(19) United States
(12) Patent Application Publication
(10) Pub. No.: US 2008/0010560 A1
(43) Pub. Date: Jan. 10, 2008

(54) Service provision system for providing various services including diagnosis of a mobile body and car audio/video apparatus used for the system

(75) Inventor: Yasuaki Morimoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/890,336

(22) Filed: Aug. 6, 2007

Related U.S. Application Data
(63) Continuation of application No. PCT/JP05/02037, filed on Feb. 10, 2005.

(51) Int. Cl. G06F 11/00

(52) U.S. Cl. 714/47

(57) ABSTRACT

A car A/V 4 has the function of freely setting conditions for acquiring data pertaining to information related to an operation condition obtained from an in-vehicle sensor of a mobile body and run environment information surrounding the mobile body. The car A/V 4 stores in-vehicle sensor data in accordance with set condition(s) for acquiring data. The in-vehicle sensor data stored in memory A of main controller 17, the navigation data stored in a second memory B, and car window photograph data stored in a third memory C of a car A/V 4 are converted into a data block for each mutually identical time identifier. The converted data block is transmitted to a controller C25 by an operation of the main controller 17. The transmitted data block is stored one by one in a hard disk 30 for each data block by an operation of controller C25.

### CROSS REFERENCE TO RELATED APPLICATION

This application is a continuation of the PCT application PCT/JP2005/002037 which was filed on Feb. 10, 2005.

### BACKGROUND OF THE INVENTION

1. Field of the Invention

The present invention relates to a service provision system that acquires information related to an operation condition of a mobile body, such as automobiles and heavy equipment, and provides various services including diagnosis.

2. Description of the Related Art

FIG. 1 is a diagram showing a conventional mobile information service system utilizing portable information equipment. In the conventional mobile information service system put forth in the following reference patent document 1, portable information equipment (e.g., personal digital assistant (PDA)) held by a user riding in an automobile 51 receives the latest road, weather, and destination information provided by an information provision service company 50. A self-diagnosis function equipped in an automobile 51 analyzes the automobile's 51 positional information acquired by a navigation system 52 and data from various sensors equipped in the automobile 51. The PDA transmits the analysis information in real time to the information provision service company 50 and automobile company 57, while the automobile company 57 constantly monitors an operation condition(s) of the user's automobile 51. Based on the analysis information, it provides the user with appropriate information in accordance with the condition(s) via the portable information equipment (e.g., PDA) carried with the user as shown in FIG. 1. A major characteristic of the conventional technique lies in the self-diagnosis function equipped in the automobile 51, pre-analyzing data acquired by various sensors equipped therein, and transmitting the analysis result constantly to the information provision service company 50 and automobile company 57 so as to enable the portable information equipment (e.g., PDA) possessed by the user to constantly receive the appropriate information.

FIG. 2 is a diagram showing a conventional vehicle information management system following up on a maintenance check of a vehicle by building up a system for exchanging a user's vehicle data of a vehicle between a user terminal and a vehicle information management company. The conventional vehicle information management system, put forth by the below-noted reference patent document 2, is configured to store vehicle data in memory card 68 by taking the data out of an electronic control unit 67, transferring the vehicle data stored on the memory card 68 to a hard disk at a user's terminal personal computer (PC) 66, and acquiring diagnosis information on a Web display screen by having the user's terminal PC 66 open the specific home page 70 provided by the vehicle information management company that manages the user's the vehicle information by way of the Internet 64, as shown in FIG. 2. Patent document 2 has further disclosed a real time diagnosis service that is configured to transfer vehicle data to a portable phone from a data extraction means equipped in the electronic control unit by way of a short distance radio communication means and display the diagnosis information on a Web screen of the portable phone in place of the Web screen of the user specific home page on the terminal PC 66.

Patent document 1: Laid-Open Japanese Patent Application Publication No. 2002-230658

Patent document 2: Laid-Open Japanese Patent Application Publication No. 2003-011747

### SUMMARY OF THE INVENTION

The above-described conventional example provides portable information equipment with the capability of transmitting and receiving at a certain time interval. This causes the problem of large telecommunication costs to the user, including a subscription fee and an annual membership fee, which results even with the reduced telecommunication cost to date.

Another problem with the above-described conventional example is that the portable information equipment does not have a function to directly import raw data from various sensors equipped in an automobile, therefore its capability of adequately diagnosing and analyzing is doubtful.

Yet another problem about the above-described conventional example is that, although the portable information equipment of the user is enabled to acquire the diagnosis information in real time, there is no function to set a data acquisition condition related to information required for a diagnosis because the data acquisition for diagnosing information is preset.

Therefore, in order to solve the above described problem, the present invention aims to provide a service provision system that acquires information related to an operation condition from an in-vehicle sensor of a mobile body and information of a run environment surrounding the mobile body, stores this information in portable information equipment, and transmits the information to a service provider by getting it in a user terminal via the portable information equipment. It then receives a service provision, including a diagnosis, which provides for a service provision system comprising the function of freely setting an acquisition condition of data related to the information and a car audio/video apparatus (A/V) for use in the system.

In order to solve the problem described above, the present invention is characterized as acquiring, and storing in portable information equipment, information related to an operation condition obtained from an in-vehicle sensor of a mobile body and information of a run environment surrounding the mobile body. The present invention is configured to get the information in a user terminal by linking the portable information equipment with a user terminal, transmitting information to a service provider that is related to the information service, and receiving a provision of a service including a diagnosis of the mobile body. The present invention is also configured to include a car audio/video apparatus (A/V) that comprises a data setup unit for setting an acquisition condition of data of an in-vehicle sensor, et cetera, and a data setup table for storing a condition that is set by the data setup unit.

The present invention is contrived to store information related to an acquired operation condition and run environment information on a user's portable information equipment. It further uses the diagnosis system of a service provider, by way of a user terminal, to transmit information related to a diagnosis service from among the stored information related to the operation condition and run environment information, and receives a diagnosis result by way of the Web; thereby bringing forth the benefit of greatly reducing a user's telecommunication cost for the diagnosis service.

It is also contrived to provide the function of setting an acquisition condition of data related to information required for a diagnosis service, thereby bringing forth a benefit of freely selecting sensor information to be acquired and a time interval for acquiring data.

### BRIEF EXPLANATION OF THE DRAWINGS

FIG. 1 is a diagram showing a conventional mobile information service system utilizing portable information equipment;

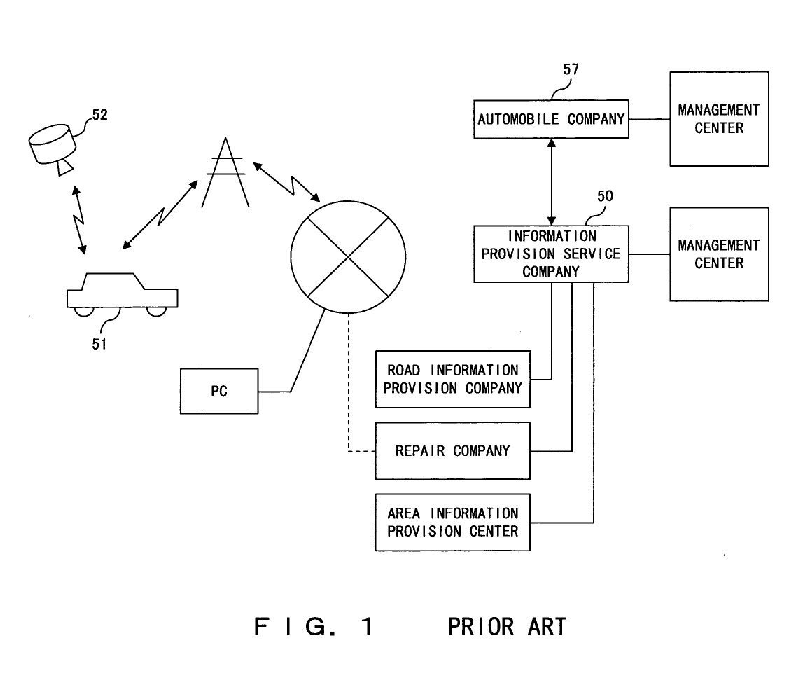

FIG. 2 is a diagram showing a conventional vehicle information management system utilizing a user terminal;

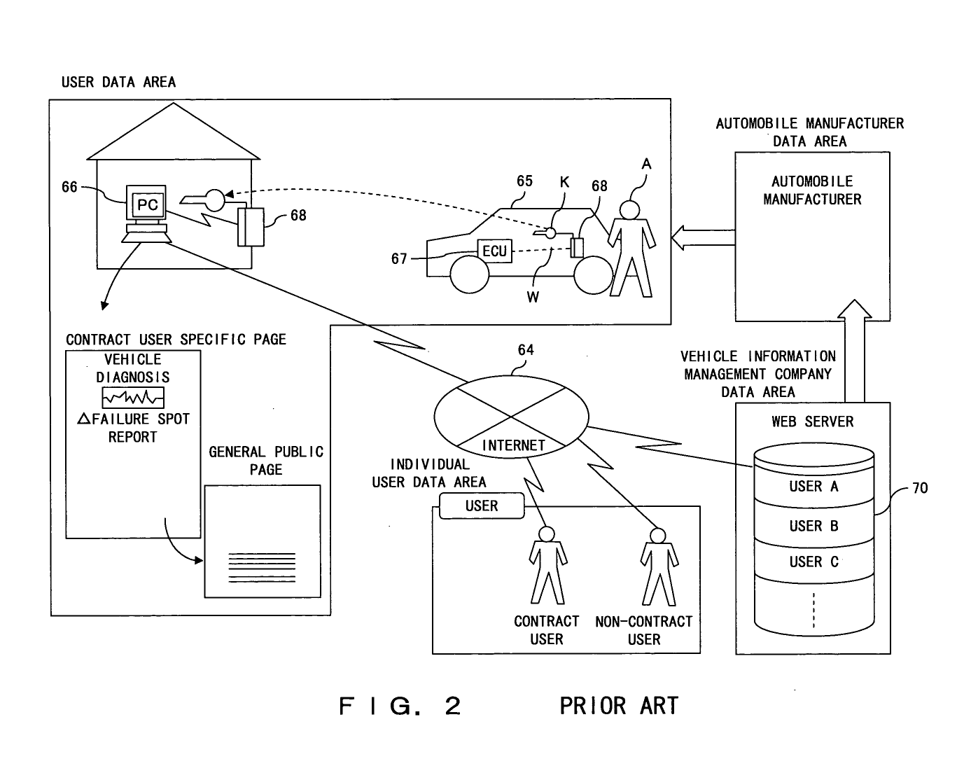

FIG. 3 is a diagram of a configuration of a service provision system, including a diagnosis according to a preferred embodiment of the present invention;

FIG. 4 is a diagram describing in further detail the content of the procedure shown by block A of FIG. 3;

FIG. 5 is a flow chart diagram of the procedure at an affiliated dealer shown by block A of FIG. 3;

FIG. 6 is a diagram further describing the major operation of the system in an automobile run scene shown by block B of FIG. 3;

FIG. 7 is a flow chart diagram of a system operation in an automobile run scene shown by block B of FIG. 3;

FIG. 8 is a diagram showing a situation wherein an action is taken to a diagnosis system provided by an automobile manufacturer from a user's home PC shown by block C of FIG. 3;

FIG. 9 is a flow chart diagram of an operation for requesting diagnosis service at the home of the PC shown in FIG. 8;

FIG. 10 is a diagram showing a configuration of an automobile manufacturer diagnosis system according to a preferred embodiment of the present invention;

FIG. 11 is a block diagram showing acquired data being processed from a portable phone, a car A/V (including a car navigation system), and an automobile, while the automobile is traveling, which is in accordance with a preferred embodiment of the present invention;

FIG. 12 is a flow chart diagram describing a retrospect scene creation service as an example of a non-diagnosis service provision according to a preferred embodiment of the present invention;

FIG. 13 is a diagram showing a first business model, which is generated when the service provision body is an automobile manufacturer according to a preferred embodiment of the present invention;

FIG. 14 is a diagram showing a second business model in which a service provision support company is separately established, according to a preferred embodiment of the present invention, in order to comprehend the first business model shown in FIG. 13, and further develop from that business model;

FIG. 15 is a diagram for describing a third business model in an attempt to cooperate with a non-life insurance company according to a preferred embodiment of the present invention;

FIG. 16 is a diagram showing a fourth business model in which a service provision support company is separately established according to a preferred embodiment of the present invention in order to comprehend the third business model shown in FIG. 15 and further develop from that business model;

FIG. 17 is a functional block diagram related to a first embodiment for implementing an emergency communication in the service provision system according to the present invention;

FIG. 18 is a functional block diagram related to a second embodiment for implementing an emergency communication in the service provision system according to the present invention;

FIG. 19 is a block diagram showing a configuration for making a hard disk, that is included in the car's A/V navigation system, as a diagnosis data storage medium in the service provision system of the present invention; and

FIG. 20 is an enlarged diagram showing the configuration of the hard disk shown in FIG. 19.

### DESCRIPTION OF THE PREFERRED EMBODIMENTS

The following is a description of the preferred embodiment of the present invention by referring to the accompanying drawings.

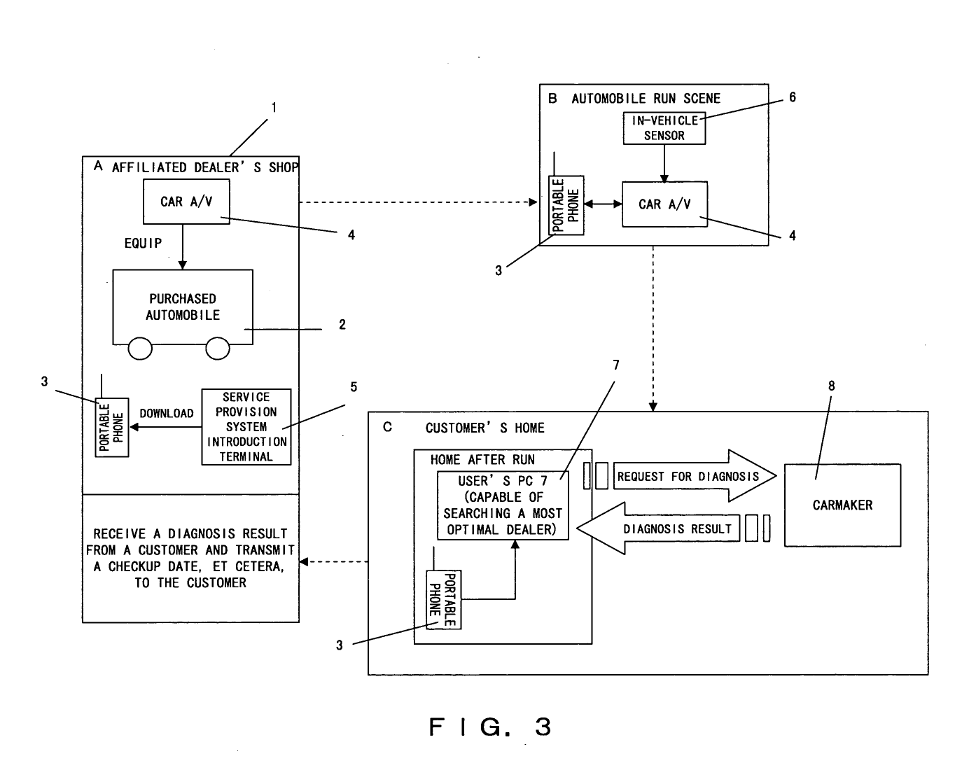

FIG. 3 is a conceptual diagram of a service provision system configuration including a diagnosis according to a preferred embodiment of the present invention. The present embodiment is described by exemplifying a portable phone as portable information equipment; it may be, however, a personal digital assistant (PDA). It is also described by exemplifying a vehicle (e.g., an automobile) as a mobile body that is a diagnosed piece of equipment; however, the equipment may be heavy equipment, a vessel, a flying body, et cetera, in lieu of being limited to an automobile. It may also be applicable to a personal use or a business use. Meanwhile, it is described by exemplifying an automobile manufacturer producing vehicles as a service provision body, and further exemplifying the case of furnishing an affiliated dealer selling vehicles of the aforementioned automobile manufacturer with a service provision system introduction terminal.

Block A of FIG. 3 is a diagram showing a shop scene of an affiliated dealer 1 for a customer user purchasing an automobile 2, where the user enters into a contract for purchasing the automobile 2 and a service contract including a diagnosis related to an operation condition of a mobile body in correlation with data acquired from a portable phone 3 and a car audio/video apparatus (A/V) 4 (including a car navigation system). Under this contract, application software enables the importation of data necessary for implementing a service, including diagnosis. This application software is installed onto the user's portable phone 3 from a service provision system introduction terminal 5 installed the affiliated dealer's 1 shop.

Block B of FIG. 3 is a diagram showing a scene of a user driving an automobile with a portable phone 3 placed at a prescribed position of the vehicle (e.g., a portable phone connection box or holder placed on the dash board.) Raw data from various sensors, that is, an in-vehicle sensor 6 equipped in an automobile 2 and information such as latitude, longitude, geographical name, road number, et cetera, are put together and transmitted from a car A/V 4 to a portable phone 3. In this case, the aforementioned data and information are converted into a prescribed format and stored in a storage medium comprised by a portable phone 3. A configuration of the storage medium comprised by the portable phone 3 is described later.

Block C of FIG. 3 is a diagram showing a scene of a diagnosis service request after a user leaves an automobile 2 behind and comes home carrying a portable phone 3 with her/him. The user makes a home PC 7 call a diagnosis system by opening a Web page that enables access to the diagnosis service provided by the automobile manufacturer 8 (hereinafter abbreviated as “carmaker”) by way of the Internet, transfers data for a diagnosis (hereinafter referenced as “diagnosis data”) stored on the storage medium of a portable phone 3 in a PC 7, and requests the diagnosis system provided by a carmaker 8 for a diagnosis service. A Web function provided by carmaker 8 is described in detail later. Note that the diagnosis service request can also be made from her/his office if there is a specific PC available, and not only from a home.

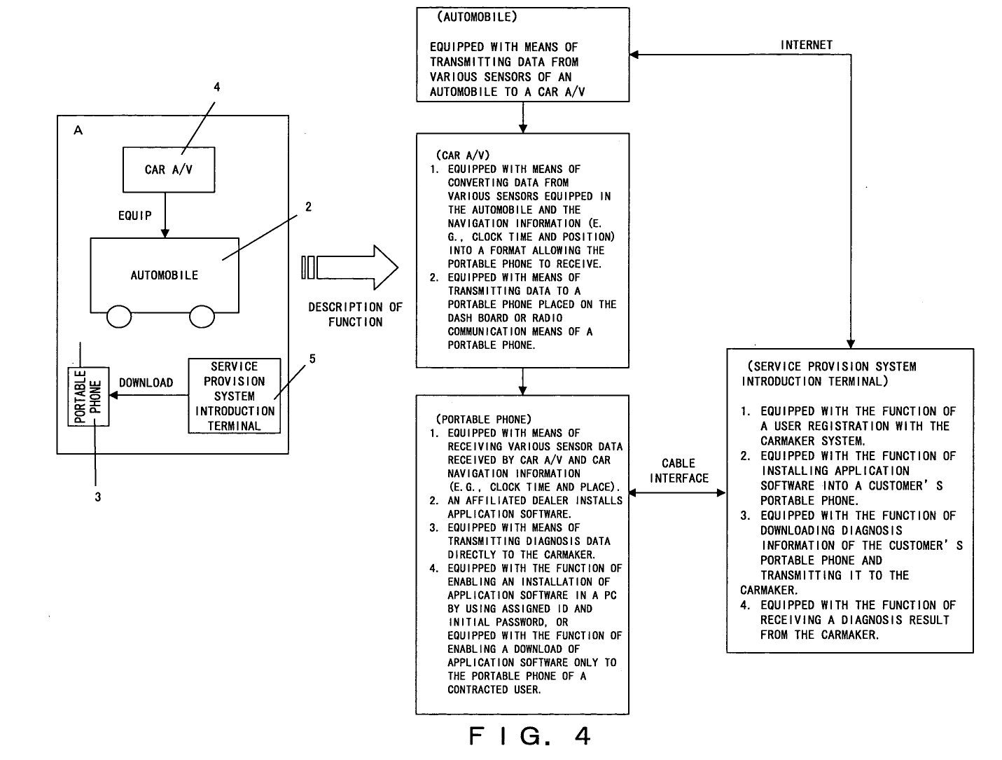

FIG. 4 is a diagram describing the content of the procedure shown by block A of FIG. 3. A means of transmitting in-vehicle sensor data to the car A/V 4 is preinstalled when the automobile is manufactured. The car A/V 4 is equipped with means for converting the data from various sensors equipped in the automobile 2 as well as navigational information (e.g., latitude and longitude) into a format that allows a portable phone 3 to receive the data. The affiliated dealer delivers an automobile 2 to the user with the means of transmitting and means for converting already equipped. Also, at the time of contracting the present service may install the application software on the user's portable phone 3 by connecting the portable phone 3 to the service provision system introduction terminal 5 via a cable interface such as a Universal Serial Bus (USB) and RS232C for receiving various sensor data of the automobile 2. Also, user identification information (e.g., ID and password) is assigned to the user for accessing the carmaker's 8 Web page so that the user can register with the carmaker. The user receives this present service by accessing the carmaker's 8 Web page by using the ID and password that was assigned to the user in her/his user identification information. Furthermore, the portable phone 3 is furnished with the function of transmitting the diagnosis information stored in the portable phone 3 to the carmaker 8 directly. The service provision system introduction terminal 5 is furnished with the function of receiving a diagnosis result from the carmaker 8.

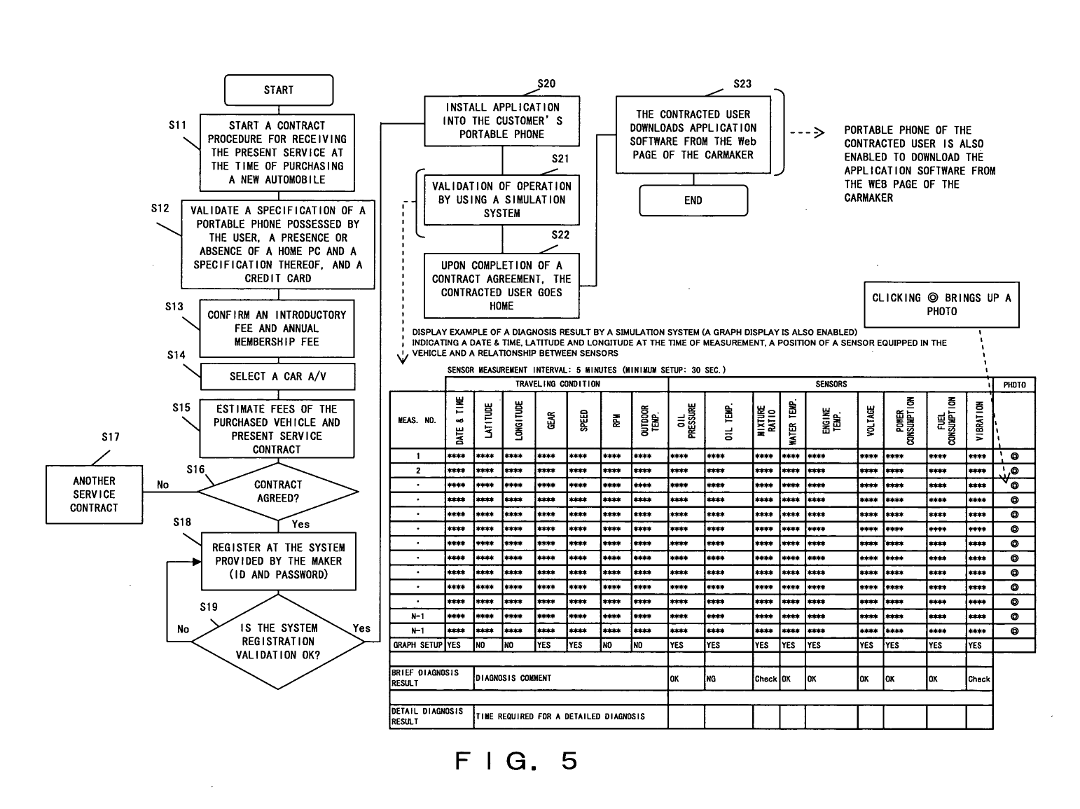

FIG. 5 is a flow chart diagram of the procedure at an affiliated dealer as shown by block A of FIG. 3. The user starts a contract procedure for receiving a service from a service provision system (sometimes abbreviated as “service” hereinafter) including diagnosis provided by the carmaker at the time of purchasing a new automobile (S11). Next is a validation of the user's portable phone's 3 specification, the presence or absence of a home PC 7 and a specification thereof, and a credit card or other payment method (S12). Next there is an explanation of a contract fee (i.e., an introductory fee) and an annual membership fee, and a confirmation of the contract content of the present service (S13). Next, a car A/V (S14) is selected and a total fee including the purchased vehicle and the present service contract (S15) is estimated. This is followed by finally entering into a contract (S16). Possible variations, such as a failure to agree to the contract, or if the user signs up for another service contract, are not discussed because they are outside the scope of the present invention (S17).

When the user agrees to the contract, a registration in the system provided by the carmaker 8 is carried out and user identification information (e.g., ID and password) is issued (S18). Next, the system registration is validated via a service provision system introduction terminal 5 (S19). In this event, the service provision system introduction terminal 5 is connected to a portable phone 3 by way of a USB or RS232C interface cable and application software is installed on the portable phone 3 (S20). The application software is configured to store, on a storage medium comprised by the portable phone 3, data from various sensors equipped in the vehicle and a car window picture and such taken by the portable phone 3 in accordance with a prescribed data format. Next there is a validation of the carmaker's 8 entire system, including a Web access, using the portable phone 3 on which the application software is installed. This application software operates by using a simulation system furnished in the service provision system introduction terminal 5. The lower part of FIG. 5 shows a display example of a diagnosis result based on the simulation system, that is, a display example of a diagnosis result of incorporating car navigation information, in-vehicle sensor data, and car window picture photographing conditions. This display example shows the diagnosis result in the form of converting the data array so as to indicate the date & time, the latitude and longitude at the time of measurement, the position of the sensor equipped in the vehicle, and the relationship between sensors as a result of the introduction of the application software. Upon completing the validation of the operation using the simulation system, the entire contract procedure is complete (S21). Upon completion of the contract agreement, the user goes home (S22), accesses the carmaker's 8 Web page by using the ID and password assigned to the user in the user identification information, and confirms the registration. Upon completion, the user is enabled to download the application software onto a home PC (S23). The user is also enabled to confirm the registration and download the application software from the contracted user's portable phone 3. This illustrates the sequence of events when entering into a service contract.

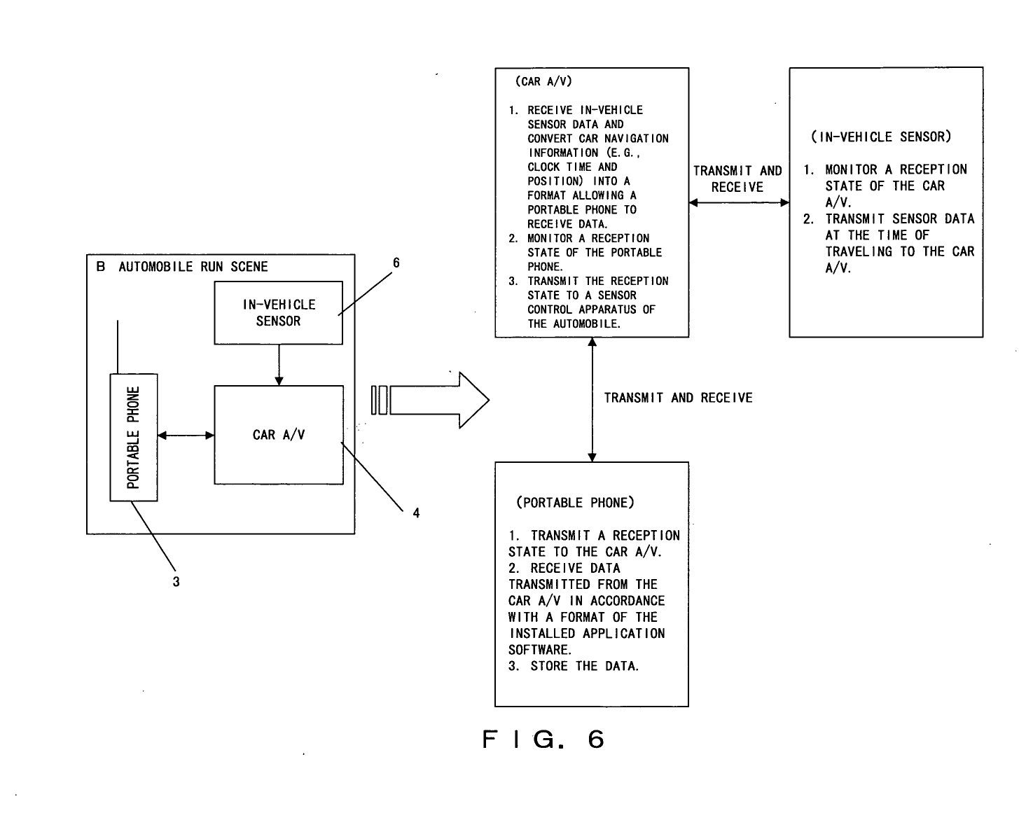

FIG. 6 is a diagram describing the major operation of the system in an automobile run scene as shown by block B of FIG. 3. The in-vehicle sensor 6 monitors a reception state of a car A/V 4 and also transmits, to the car A/V 4, at the time of a run. While monitoring a reception state of the portable phone 3, the car A/V 4 converts car navigation information (e.g., latitude, longitude and such) and in-vehicle sensor data into a format allowing the portable phone 3 to receive and transmit data at a data transmission interval set by the user. Meanwhile, the car A/V 4 transmits the reception state of the car A/V from the in-vehicle sensor data to a sensor control apparatus of the automobile. The portable phone 3 transmits a reception state to the car A/V 4 and converts the in-vehicle sensor data, and the transmitted data from the car A/V 4, into a data array in accordance with a prescribed format and stores the data in a storage medium (not shown herein). The portable phone's 3 storage medium stores the photographed car window picture, the car navigation information (e.g., latitude and longitude), and the in-vehicle sensor data.

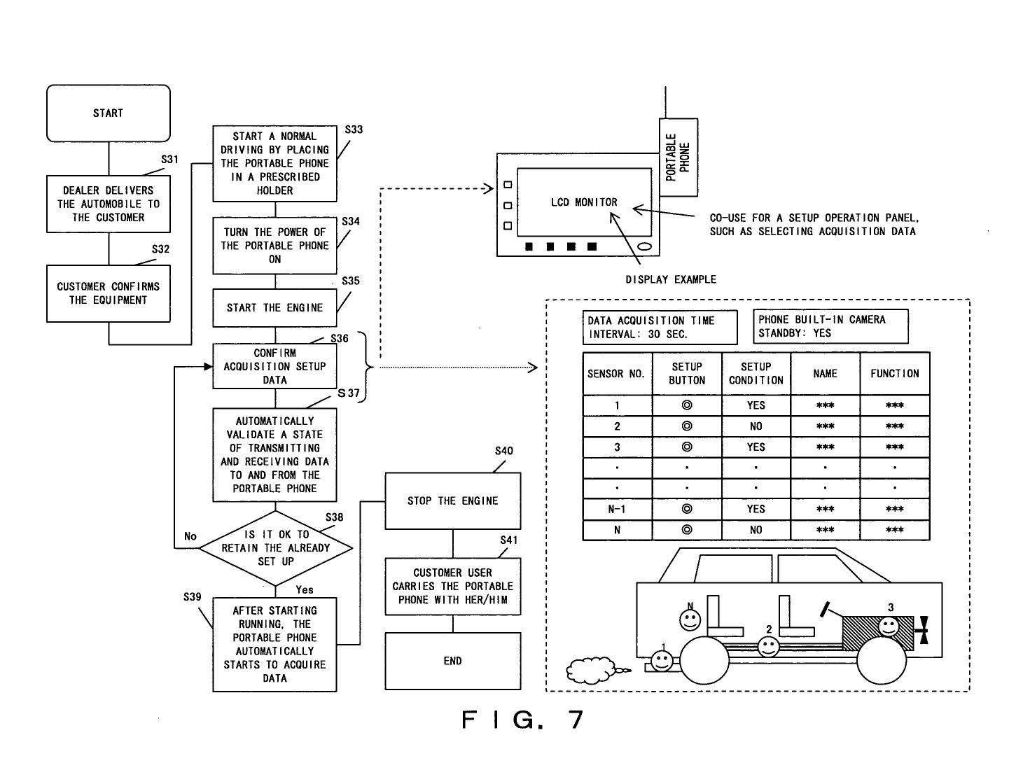

FIG. 7 is a flowchart diagram of a system operation in an automobile run scene as shown by block B of FIG. 3. First, the dealer 1 delivers the automobile to the customer user (S31). Following a confirmation of the automobile's 2 equipment, which was delivered by a dealer 1 (S32), normal driving (i.e., a run) may begin by placing a portable phone 3 in a prescribed holder (S33). When a portable phone 3 is placed in the prescribed holder, the battery capacity is increased by means of a recharging function for the portable phone 3. If there is enough battery capacity, a data exchange with the car A/V 4 via an existing wireless communication means (such as Blue-tooth) is enabled. Next the power on the portable phone (S34) is turned on. Then the engine (S35) is started and the acquisition setup data (S36) is confirmed. The confirmation of the acquisition setup data is used to confirm the acquisition data required for a diagnosis displayed on a liquid crystal display (LCD) monitor on the car A/V 4, as displayed in the example shown in the lower part of FIG. 7. The display on the LCD monitor is also configured to enable confirmation of setup content such as a sensor position in the vehicle, a time interval of acquiring data, the existence of built-in digital camera function on the portable phone 3 when in a standby state, et cetera. Next the transmission and reception of data to and from the portable phone 3 (S37) is validated, followed by a confirmation of whether an already set-up state of acquisition data, which is required for a diagnosis, is to be retained (S38). If the setup is to be changed, the process returns to step S36 for entering a change procedure. The LCD monitor display screen is also used for a setup operation panel to enable a change of acquisition data by selecting a prescribed position to be changed in the operation panel. If the setup is not changed, the data after the vehicle starts running is automatically stored in the storage medium on the portable phone 3 (S39). The configuration is such that the built-in camera photographs a car window picture coinciding with the acquisition of the in-vehicle sensor data. The data and picture are combined with the latitude and longitude data acquired from the navigation system, thereby making it possible to grasp a run environment accurately at the time the data is acquired. When the customer user stops the engine and leaves the automobile 2 (S40), the user takes the portable phone 3 out of the placement holder to carry with her/him (S41). This illustrates the processes when driving an automobile.

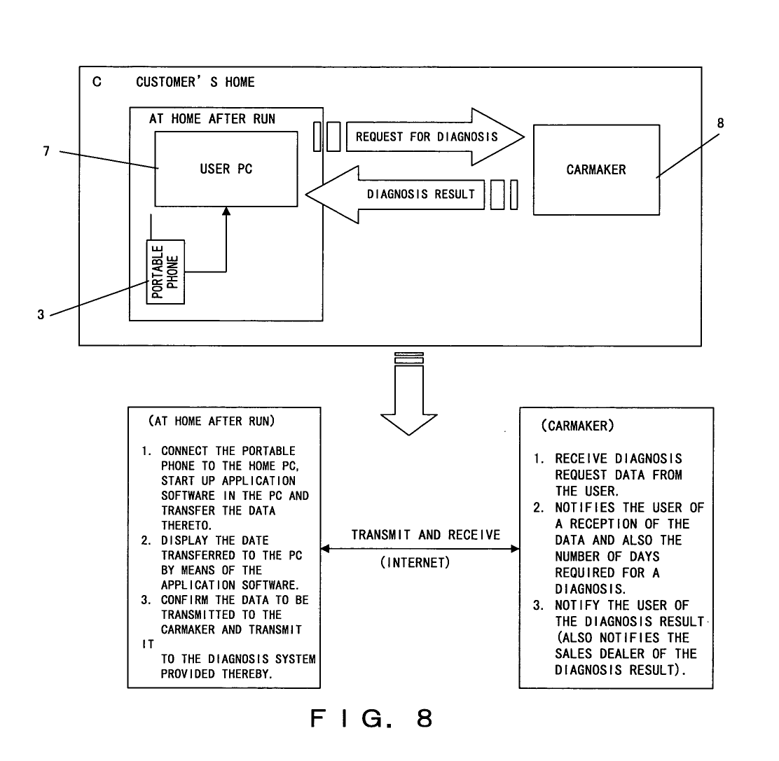

FIG. 8 is a diagram that shows the action of taking a diagnosis system, provided by the automobile manufacturer, from a user's home PC as shown by block C of FIG. 3. The user connects a portable phone 3 to a home PC by way of an interface cable such as a USB. Having started up the home PC, the user inputs the ID and (initial) password to access the service provision system provided on the carmaker's 8 Web page, wherein a diagnosis service can be obtained. If the application software for transferring data stored on a portable phone 3 to a home PC 7 has not been installed, the user downloads the software from the Web page of the service provision system. Opening the application software on a PC, the user transfers the desired data from a portable phone 3 to a PC 7 in accordance with instructions on the Web page and displays the data therein. The user validates the data to be transmitted to the carmaker 8 and presses a transmit button to transmit the data (i.e., diagnosis data). Having received the data (i.e., diagnosis data), the carmaker 8 confirms the data and transmits the number of days required for issuing a diagnosis result to the user. Having put together a diagnosis result, the carmaker 8 transmits it to the user who notifies the carmaker 8 that it has been received. If the user has already notified the carmaker 8 of her/his electronic mail (e-mail) address, the carmaker 8 may transmit the diagnosis result simultaneously by e-mail. Sending the diagnosis result to the sales dealer makes dealer support easier.

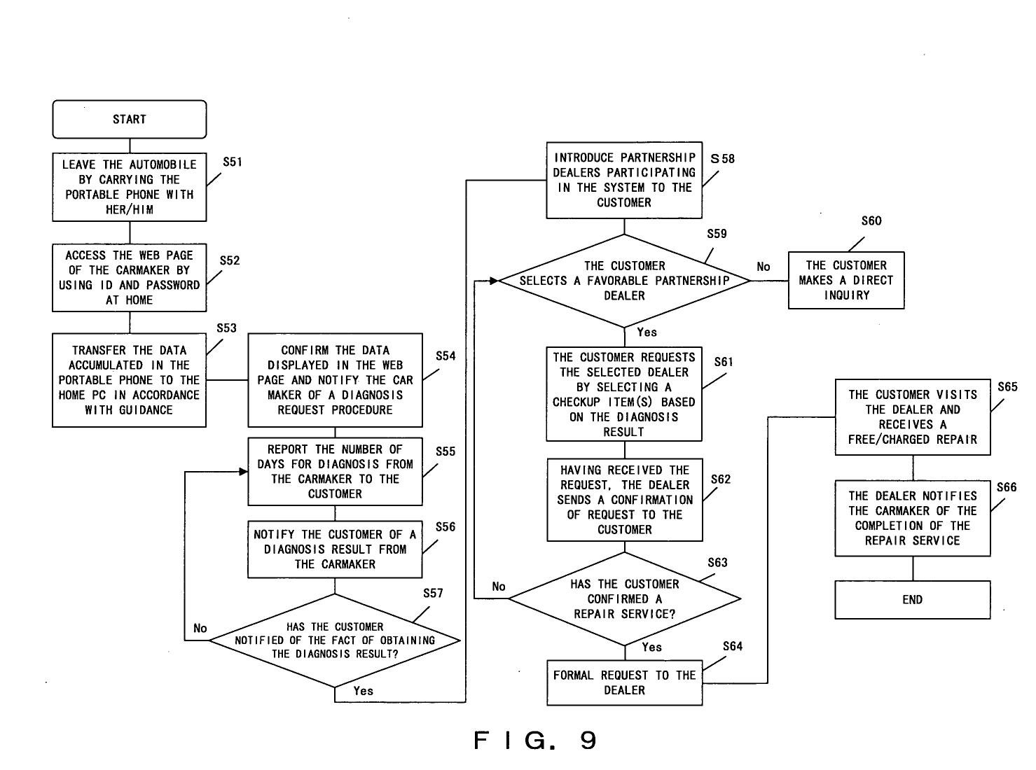

FIG. 9 is a flowchart diagram of an operation for requesting a diagnosis service at a home PC, as shown in FIG. 8. First, the user leaves the automobile and takes the portable phone 3 with her/him (S51). The user connects the portable phone 3 to a PC by way of a USB interface cable, or other cable. The user turns on the power to the PC 7 and accesses the contracted carmaker's 8 Web page, which provides a diagnosis service by inputting the ID and (initial) password (S52). Next, desired data from the data stored on the portable phone 3 is transferred in accordance with a guidance of the Web page (S53). The user is required to pay attention so that unnecessary data is not displayed, e.g., data pertaining to privacy such as latitude, longitude, and car window pictures. Having confirmed the data to be transmitted, the user clicks a confirmation button and then a transmit button to notify the carmaker 8 of the diagnosis request procedure (S54). On the other hand, having received the diagnosis data transmitted from the user, the carmaker 8 notifies the user that the diagnosis data has been received and the number of days required for issuing a diagnosis result (S55). Having put together the diagnosis result, the carmaker 8 notifies the user of the diagnosis result (S56). If the carmaker 8 sends the diagnosis result to the sales dealer, or the sales dealer's head office, the dealer can organize a service support system prior to a user's visit. The user notifies the carmaker 8 that a diagnosis result (S57) has been obtained. The carmaker introduces dealer(s) that have participated in the system (S58) (hereinafter “participating dealer”) on the Web page. The user selects a nearby and convenient participating dealer (S59). The reason for allowing the user to select a convenient participating dealer is because there may be cases where having the user visit the sales dealer is inconvenient because of a move by the user several years after contracting with the sales dealer. Thus the system is built in consideration of the user. It is of course possible for the user to make an inquiry to the carmaker 8 if the user does not select the participating dealer at her/his discretion (S60). Then, the user adds her/his own request (e.g., a checkup item, a visit date or such) and sends the diagnosis result to the selected dealer (S61). Having received it, the dealer confirms the user's request (S62). The confirmation may be sent by way of a Web page or e-mail. Having confirmed the content of the service and the readiness of the dealer, the user notifies the dealer of the confirmation (S63) and makes a formal request to the selected dealer (S64). The user later visits the dealer and receives a free service or charged service such as checkup and/or repair (S65). Having completed the checkup and/or repair of the user's automobile, the dealer reports the contents of the completed checkup and/or repair to the carmaker 8 (S66). This report is stored on a service system database provided by the carmaker 8, and utilized to develop new vehicles and equipment. This is illustrative of the operations used when requesting a diagnosis service by using a PC.

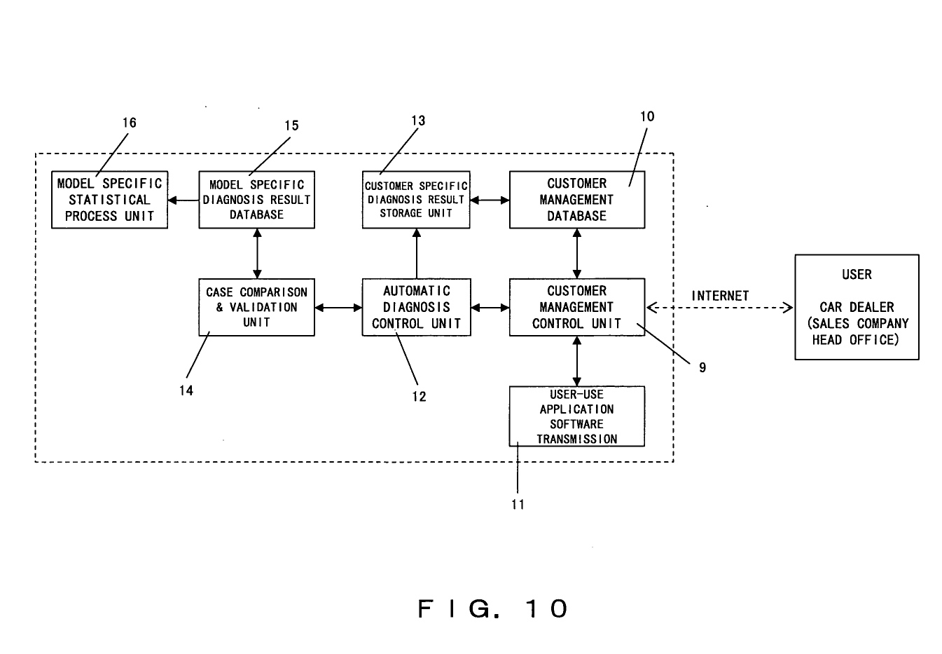

FIG. 10 is a diagram showing a configuration of an automobile manufacturer diagnosis system according to a preferred embodiment of the present invention. With regard to the diagnosis data transmitted from the user via the Internet, a customer management control unit 9 searches a customer management database 10 to confirm whether or not the user has been registered, and registers the user's latest access situation in the customer management database 10. If the contracted user requests application software to be downloaded, a user-use application software transmission control unit 11 issues permission to download. Next diagnosis data that is transmitted by the user is inputted into an automatic diagnosis control unit 12, which diagnoses and analyzes it. The automatic diagnosis control unit 12 is enabled to automatically grasp an altitude while running based on position data (i.e., latitude and longitude) that the user has transmitted by using a map database (not shown herein). The map database is comprised of an automatic diagnosis control unit 12. A diagnosis result output from the automatic diagnosis control unit 12 is stored on a customer specific diagnosis result storage unit 13 for each user. The diagnosis result is subjected to validity verification while a case comparison & validation unit 14 compares historically accumulated cases, by using an automatic diagnosis control unit 12, with cases of the applicable model stored in a model specific diagnosis result database 15. A model specific statistical process unit 16 analyzes variations in the diagnosis results based on the model specific diagnosis result database 15. The carmaker 8 is advantaged by having the capability of improving a specific model and/or making good use of the diagnosis data to develop new vehicles and equipment based on the accumulated data in the company's diagnosis system database. Upon completing a validity verification of the diagnosis result, the carmaker 8 adds a brief comment to the diagnosis and checkup item for each unit, (e.g., an engine unit, a power transmission unit, a suspension system, a braking system, et cetera), automatically searches the sentence examples retained by the model specific diagnosis result database 15 for specific measure(s) for future action, adds it (or them) to the diagnosis result form, and reports the resultant to the user and sale dealer (or affiliated dealer) via the Internet coinciding with a notification schedule for the diagnosis result. Note that the configuration is such that user diagnosis data can be stored on a the user's PC 7 hard disk by means of the application software that the contracted user downloaded to receive diagnosis result notifications and provisions of other services (e.g., a retrospect scene creation service—which is described later). However, the customer can open the customer PC's 7 Web page only when accessing the carmaker's 8 Web page by inputting the ID and password.

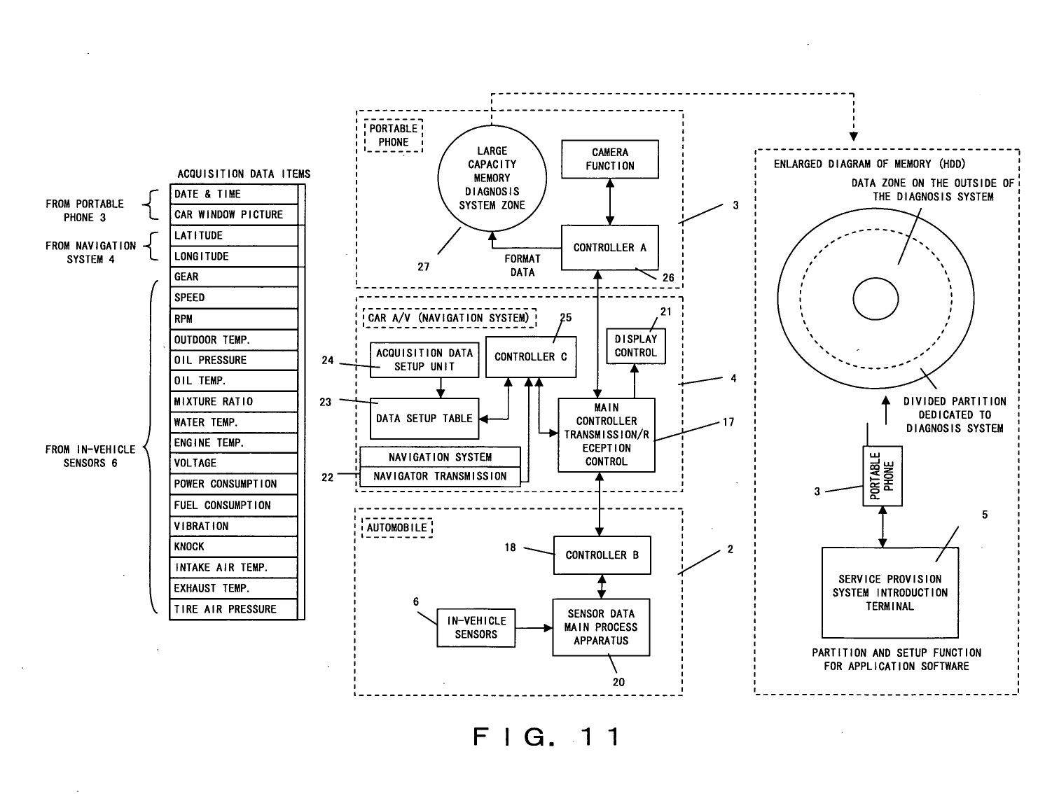

FIG. 11 is a block diagram showing acquired data being processed from a portable phone, a car A/V (including a car navigation system), and an automobile, while the automobile is traveling, which is in accordance with a preferred embodiment of the present invention. A main controller of the car A/V 4 (including a car navigation system) controls the transmission and reception of data between the automobile 2, the controls, and the portable phone 3. The present embodiment is configured in a manner that the car A/V 4 (including a car navigation system) comprises the main controller 17; however, in an alternate configuration the automobile 2 may comprise the main controller 17.

An analog/digital-(A/D) converter is configured to convert various sensor data acquired from the in-vehicle sensors 6 equipped in the automobile 2, control an array of the various sensor data as digital data, and add an identification code (not shown in a drawing herein), such as a sensor identifier, to each element of the array data. It is also configured to add the time for acquiring data to at least the head or tail end of the array data at a set time interval, via controller A26 or C25 and main controller 17, by using a clock function comprised by car A/V 4 (including a car navigation system) or portable phone 3. The resultant is then stored in a memory unit (not shown in a drawing herein) of a sensor data main process apparatus 20 by a function of controller B18. Then, the controller B18 calls the acquisition time stored in the memory unit (not shown in a drawing herein) of the sensor data main process apparatus 20 and the data array (to which the sensor identifier is added in accordance with a transmission control signal transmitted from the main controller 17), transmits it to the main controller 17, and stores it in a first memory A (not shown in a drawing herein) within the main controller 17. Data acquisition conditions, such as a car navigator setup, in-vehicle sensor setup, car window picture setup, and data acquisition time interval setup, are set in the acquisition data setup unit 24 of car A/V 4 (including a car navigation system). Incidentally shown on the left side of FIG. 11 is a list of acquisition data items with respective corresponding data acquisition sources. The conditions set by the acquisition data setup unit 24 are stored in nonvolatile memory (not shown in a drawing herein) in a data setup table 23, and are automatically called up by the main controller 17 when the engine is started. A navigator transmission unit 22 controls the navigator data array, adds an identifier (not shown in a drawing herein) for each piece of data to each element in the data array, further adds the time the data was acquired at a setup time interval to at least the head or tail end of the data array via a necessary controller by using the clock function comprised by car A/V 4 (including a car navigation system) or portable phone 3 by a function of the controller C25, and stores the resultant in a memory unit (not shown in a drawing herein) of the navigator transmission unit 22. Then, the controller C25 calls up the data array to which the acquisition time and identifier are added, which is then stored in the memory unit (not shown in a drawing herein) of the navigator transmission unit 22, then it is transmitted to the main controller 17 and stored one time in a second memory B (not shown in a drawing herein) within the main controller 17; all in accordance with a transmission control signal of the main controller 17. Meanwhile, in portable phone 3, the controller A26 controls and adds sequentially photographed car window picture data and a photographing time identifier (not shown in a drawing herein) of the aforementioned data to link with the clock function comprised by car A/V 4 (including a car navigation system) or portable phone 3. The resultant is then transmitted to the main controller 17 and stored one time in a third memory C (not shown in a drawing herein) within the main controller 17; all in accordance with the data setup table 23. The in-vehicle sensor data stored in memory A, the navigation data stored in the second memory B, and the car window picture data stored in the third memory C of the main controller 17 are converted into a data block for each mutually coincident time identifier. The converted data block is transmitted to the controller A26 of the portable phone 3 via the operation of the main controller 17. The transmitted data block is converted in accordance with the format of the application software, which is pre-stored in a large capacity storage unit 27, that controls a display and the data array via the operation of the controller A26 so as to be compatible with the operation of a user's home PC. The transmitted data block is sequentially stored in the large capacity storage unit 27 retained by the portable phone 3. The large capacity storage unit 27 uses a compact hard disk (HDD), nonvolatile semiconductor memory, or other memory apparatus. In the present embodiment, after the user signs up for a service provision contract, including diagnosis, the storage unit 27 is equipped in a portable phone and is configured to make a diagnosis-use root directory when the application software is installed in the portable phone 3. This makes it possible to automatically refer to the diagnosis-use directory and make use of diagnosis-use data on the user's PC when accessing the carmaker's Web page that contains storage unit data 27 equipped in the portable phone 3. When the user make use of a portable phone's diagnosis-use accumulated data in the home PC and stores the diagnosis-use accumulated data on a PC storage apparatus—or another storage apparatus (not shown in a drawing herein)—an addition mechanism for automatically erasing the accumulated data, or the directory, from a storage unit 27 is equipped on a portable phone 3. This makes it possible to secure a storage zone for the diagnosis-use data that is constantly on a storage unit 27 of portable phone 3, and makes it possible to acquire diagnosis-use data securely. As shown in the enlarged diagram on the right side of FIG. 11, to secure the diagnosis-use data zone, certain zones of a storage unit 27 are divided and equipped on a portable phone 3 using a different partition than the storing data zone. Typically, setting a specific zone for a diagnosis system makes it possible to always secure a certain diagnosis-use data zone when using the portable phone. In this case, it is only possible to access a divided partition on a storage unit 27 for the carmaker's Web page. The application software of the service provision system (including diagnosis) is accommodated in the partition, thus enabling the installation of an operating system (OS) that is dedicated to the service provision system—including diagnosis. When the user signs up for the present contract, the setup zone is carried out by the service provision system introduction terminal 5, which connects a portable phone 3 via a cable interface such as a USB or RS232C. Note that it is preferable to set the divided partition on the outer circumference part of a hard disk (HDD) in terms of a transfer rate. Meanwhile, if a partition has not been set in the large capacity storage unit 27 of the user's portable phone 3, the service provision system introduction terminal 5 functionally makes the data stored on the user's portable phone's 3 storage unit 27 take shelter in the storage unit (not shown in a drawing herein) of the service provision system introduction terminal 5, this sets a partition, installs the application software, and rearranges user data that has been stored on a storage zone on the outside of a set partition. The user data, which has taken shelter on the storage unit (not shown in a drawing herein) of the service provision system introduction terminal 5, is of course automatically erased from the storage unit (not shown in a drawing herein) when the above described setup process is finished.

As described above, a diagnosis request is made from the portable information equipment, to the user's home or office PC, to the carmaker's Web page that puts together data on time and/or travel distance. Therefore the carmaker is not required to process it in real time, thereby providing a beneficial secure service with an extremely low likelihood of telecommunication failure. Furthermore, since there is no need to transmit a diagnosis result in real time to a user on the move, there is no telecommunication fee required for the carmaker's normal service. In the present embodiment, if each of the 400 thousand contracted cars requests diagnosis a month, the carmaker is required to build a system capable of dealing with ten requests per minute. While it is also possible to access the carmaker's Web page, download a diagnosis program, and have the user do a diagnoses; it can be configured to also have the diagnosis result sent back to the carmaker so that the carmaker can benefit by accumulating a database. If a diagnosis program is provided for each vehicle model, an update is only required for minor or full model changes in the model.

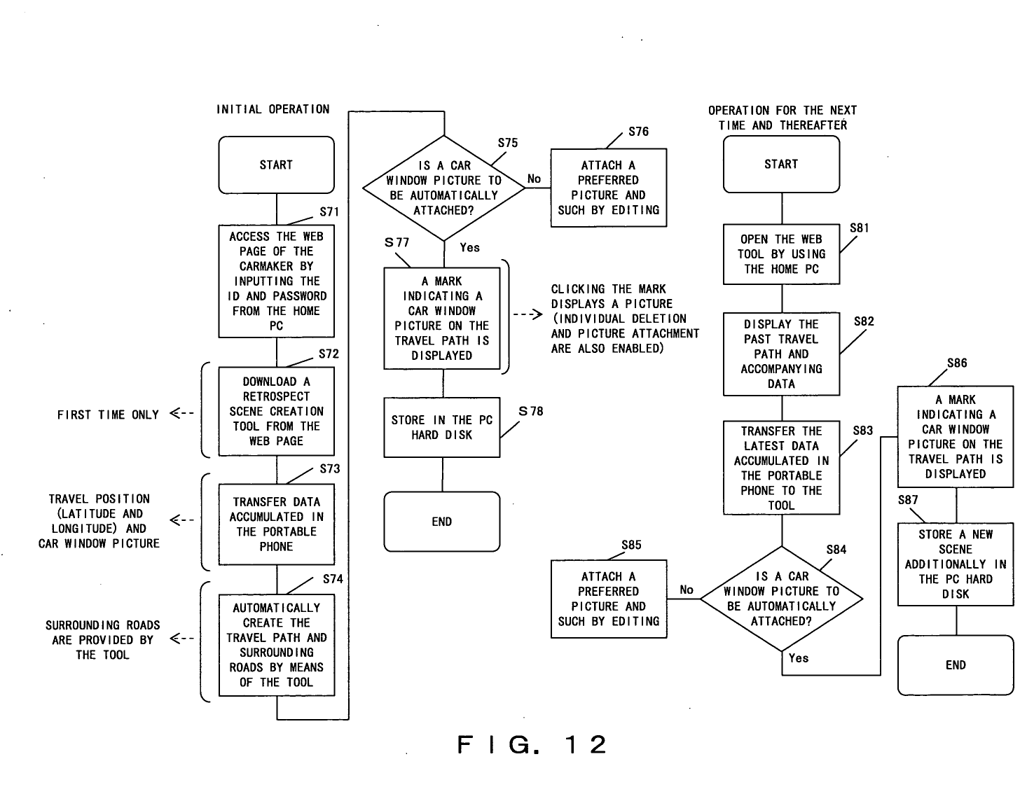

FIG. 12 is a flow chart diagram describing a retrospect scene (e.g., an album) creation service as an example of a service provision other, than a diagnosis service, according to a preferred embodiment of the present invention. This service enables the user to utilize the data accumulated on the portable phone 3 to make a retrospect scene (e.g., an album) on a home PC. The user accesses the carmaker's Web page by inputting the ID and password (S71). The user downloads a retrospect scene creation tool from the Web page (S72). This download is only carried out during the customer's initial operation. The user transfers travel path data (i.e., latitude and longitude) and the car window picture photographs, that are accumulated during travel, from a portable phone 3 to the PC (S73) which operates with the Web page's guidance tool and automatically creates the travel path and surrounding roads (S74) (note that the surrounding roads are prepared by the tool.) Then, the user judges whether the car window picture should be automatically attached to the created travel path and surrounding roads (S75). If an automatic attachment is not carried out, the user may edit (S76) the pictures by attaching a preferred picture photographed by a digital camera or a preferred car window picture. If an automatic attachment is performed, a mark (refer to the lower right corner of FIG. 5) is displayed to indicate a car window picture on the travel path (S77). Clicking the mark makes it possible to display a car window picture or attach another picture by deleting each car window picture individually. This creates a retrospect scene (e.g., an album) that can be used to remember a car trip (at a travel destination) and travel path. The created retrospect scene data is stored on the hard disk of the PC and ends the process (S78). As a result, one can enjoy a retrospect scene (i.e., an album) integrating the memories of the car trip (at a travel destination) and travel path. Note that the tool is configured to be functioned on the Web page only when accessing a Web page, and that the carmaker's Web page needs to be open for making use of the stored data on the PC.

When utilizing the retrospect scene creation service on subsequent occasions, the user opens the Web page using a home PC (S81), and makes use of the data stored on the hard disk of the PC (i.e., the past travel path and accompanying data in the Web page (S82).) Then the user transfers the latest data accumulated on the portable phone to the tool (S83), and then judges whether or not to carry out an automatic attachment of a car window picture to the travel path and surrounding roads (S84). If the automatic attachment is not carried out, the user may edit (S85) the picture by attaching a favorite picture photographed by a digital camera, or a favorite car window picture. If the automatic attachment is carried out, a mark (refer to the bottom rightmost part of FIG. 5) indicating a car window picture is displayed in the travel path (S86). The new retrospect scene (i.e., an album) integrates the memories of the car trip (to the travel destinations) and travel path. Thusly a new retrospect scene data is created and stored on the hard disk of the PC, which ends the process (S87). As a result, the user may enjoy the new retrospect scene (i.e., an album) by integrating the memories of the car trip (to the travel destinations) and the travel path.

Next is a description of examples of service provisions, other than the above described retrospect scene creation service. The present service (although it is not shown in a drawing) is configured to enable the user to access the carmaker's Web page from a home PC after accumulating local information (i.e., sightseeing information in a local area and advertisement information) on a storage medium of a portable information equipment via a car A/V, and refer to the local information stored on the storage medium of the portable information equipment in the Web page (hereinafter “local information browse service”). That is, it is configured to store local information provided by the Web along with diagnosis data on the storage medium of the portable information equipment used for the service provision system including diagnosis. It is further configured to permit a user to access a carmaker's Web page from a home PC after the user comes home, thereby enabling the user to refer to the local information stored on the storage medium of the portable information equipment. Specifically, it is configured to accumulate the diagnosis information obtained by way of the car A/V 4 during a car trip and the local information on the user's portable phone 3, and then, after leaving the car, access the carmaker's 8 Web page from a home PC 7, and refer to the local information accumulated by the portable phone 3 on the Web page. This configuration enables thorough access to the local information obtained during the car trip (in the travel destinations) or on a commuting route. Although there has conventionally been a service for obtaining local information (such as advertisement on the Web) via a car navigation system, the configuration has not enabled the user to thoroughly look, hear, or utilize the local information provided while driving a car. Contrarily, in accordance with the present invention, the local information browse service is configured to make it possible to store the local information obtained during the car trip on a storage medium of a portable information equipment and access the carmaker's Web page from the user's home PC after the user comes home; thereby enabling the user to thoroughly look, hear, or utilize the local information provided while driving a car. This service, coupled with a diagnosis service available for the user, provides the carmaker 8 with invaluable vehicle running data for the carmaker 8.

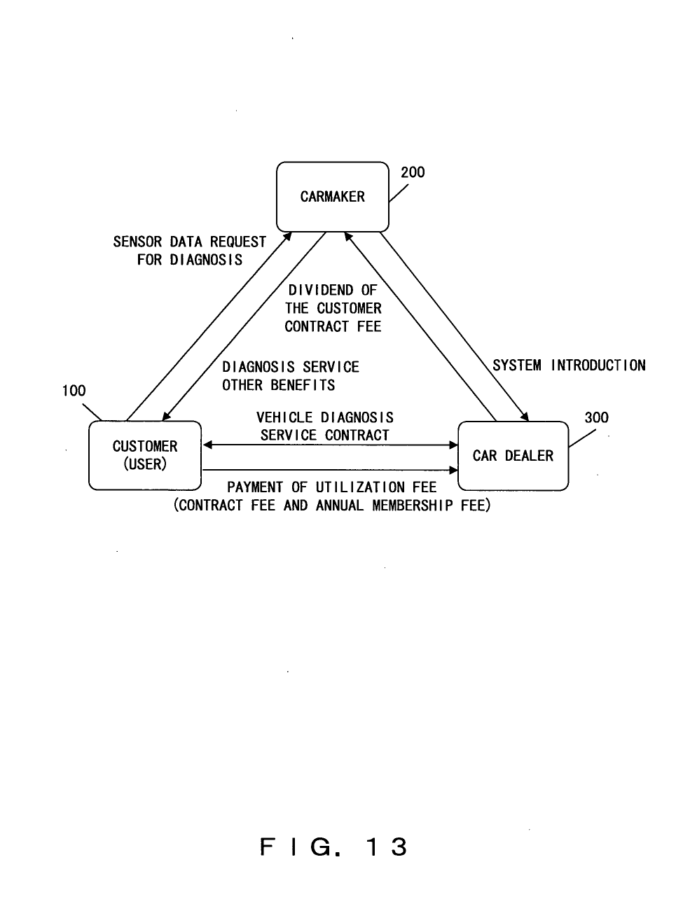

FIG. 13 is a diagram showing a first business model, according to a preferred embodiment of the present invention, which is generated when the service provision body is an automobile manufacturer. As described in FIGS. 3 through 10, a carmaker 200 carries out a contract procedure with a customer 100 (i.e., a user) at a car dealership 300, in order to for a user 100 to sign up for a service provision contract, including a vehicle diagnosis, and the user 100 need pay a utilization fee (a contract expense and an annual utilization fee) with a credit card or other method of payment. The carmaker 200 furnishes the car dealer with equipment and software required to utilize the system and pays a part of the utilization fee that was collected from the user 100 as a contribution fee in accordance with the contribution of the car dealer 300. An indicator for the contribution fee may include the income from the service contract, the improvement of the development efficiency, or the monetary benefit to the carmaker 200 derived from the utilization of the built up collection of diagnosis data. These items can be expressed numerically for an accounting by the carmaker 200; therefore, they would probably constitute a high accuracy indicator. A non-monetary benefit may include gauging customer satisfaction by collecting questionnaires from customers 100 and making improvements from them. An expected monetary benefit to the car dealer 300 includes a dividend from the income of the contract and an increased income on repair and replacement parts resulting from the increased number of users requesting repairs. A non-monetary benefit includes an increase in direct contact with the user 100, which improves user 100 confidence.

Benefits for the user 100 include monetary benefits such as preventing major repairs and non-monetary benefits such as the user's sense of security that the vehicle can always be driven securely and the user's own recognition of the importance of prevention. An online-system diagnosis service has conventionally been proposed; however, a real time service for a user has a high risk of excessive telecommunication cost from the portable phone in addition to the contract fee and annual membership fee. Therefore, there is a risk of increased cancellations due to the increased payment required by the user. Meanwhile, the issuance of a diagnosis failure during a run increases a user's sense of insecurity. Furthermore, if a message indicating that the defect has lessened is repeated, then after a certain length of time there is a risk of the user not trusting the real time diagnosis service. Contrarily, according to the present invention, the diagnosis provision service is capable of not only eliminating a user's sense of insecurity in advance, but also providing a fundamental diagnosis service for enabling the user to concentrate on the drive. The diagnosis provision service is further capable of building up a substantial amount of data to use in a database that allows the carmaker to make developments and improvements on behalf of the carmaker; thereby making it possible to continue a high quality diagnosis service.

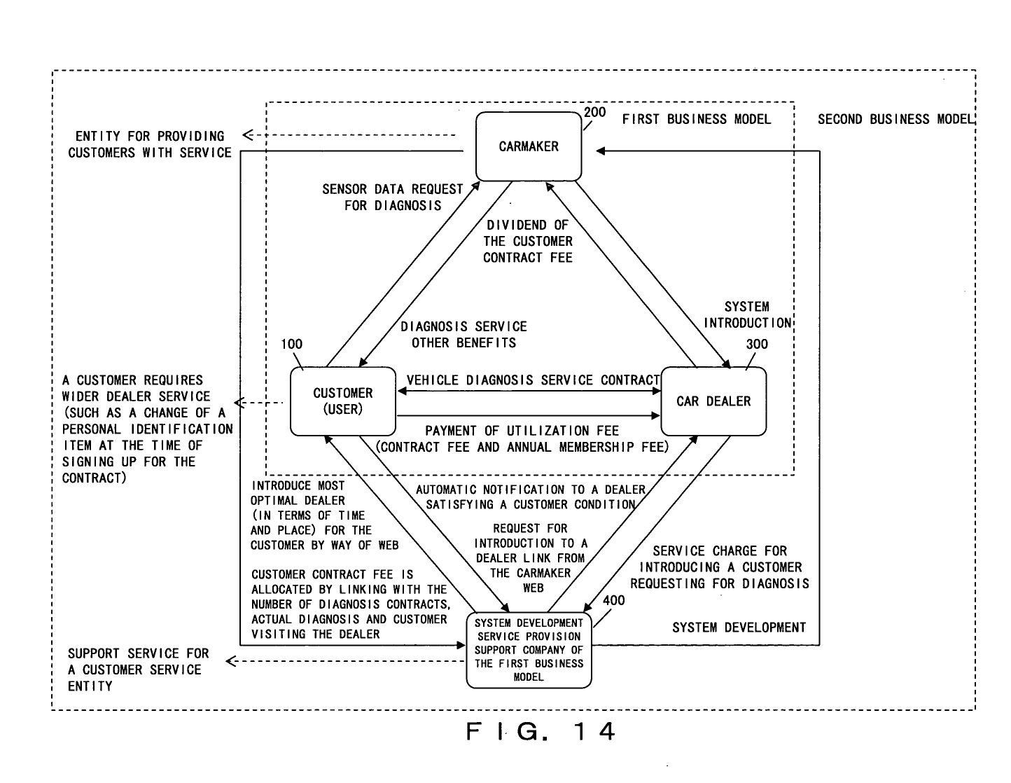

FIG. 14 is a diagram according to a preferred embodiment of the present invention that shows a second business model in which a service provision support company is separately established to comprehend the first business model shown in FIG. 13 and further develops that business model. Referring to FIG. 14, a service provision support company 400 develops a system related to the present business model for a carmaker 200, and receives an allocation of a user's contract fee for linking numerous diagnosis service contracts, a number of actual diagnosis, and dealer visits by the users 100. The service provision support company 400 carries out an installation, maintenance/management, and updates the system related to the present business model for the car dealer 300, and also interfaces between user's 100 and car dealer's 300. An examples of interfacing between user's 100 and car dealer's 300 include an periodic updates the car dealer's 300 service provision content that is related to the management of the carmaker's 200 Web page. On the Web page, the user 100 may search for the most optimal dealer (in terms of time and geography) for the present contract, or request to be introduced to a dealer by linking to the carmaker's 200 Web page and also automatically notifying a dealer that satisfies the condition; thereby the request and complaint are processed with regard to the system related to the present business model. Even such a service provision makes it possible to reduce the management load on the carmaker 200 without damaging the carmaker's 200 security. The second business model exposes the service provision support company 400 that would otherwise be fundamentally invisible in the first business model's domain. The service provision support company 400 collects a contribution fee from a carmaker 200 based on an indicator, such as a growth in the contract amount and/or number of customers 100, or an improved efficiency of development and improvement by the carmaker 200, or an improved profit by the car dealer 300.

Benefits of the second business model shown in FIG. 14 include a monetary benefit for the service provision support company (400) that appears in the present business model, an ability to collect a contribution fee based on the amount paid by users in a service contract, and a number of contracted dealers and users may be introduced to each other. Non-monetary benefits for the company (400) include the ability to plan to improve efficiency in system development, maintenance management, and update present business models by measuring the degree of satisfaction from the carmaker, car dealer, and user. Note that the monetary benefit and non-monetary benefit to the user, car dealer, and carmaker are similar to the first business model shown in FIG. 13; therefore, a description is omitted here.

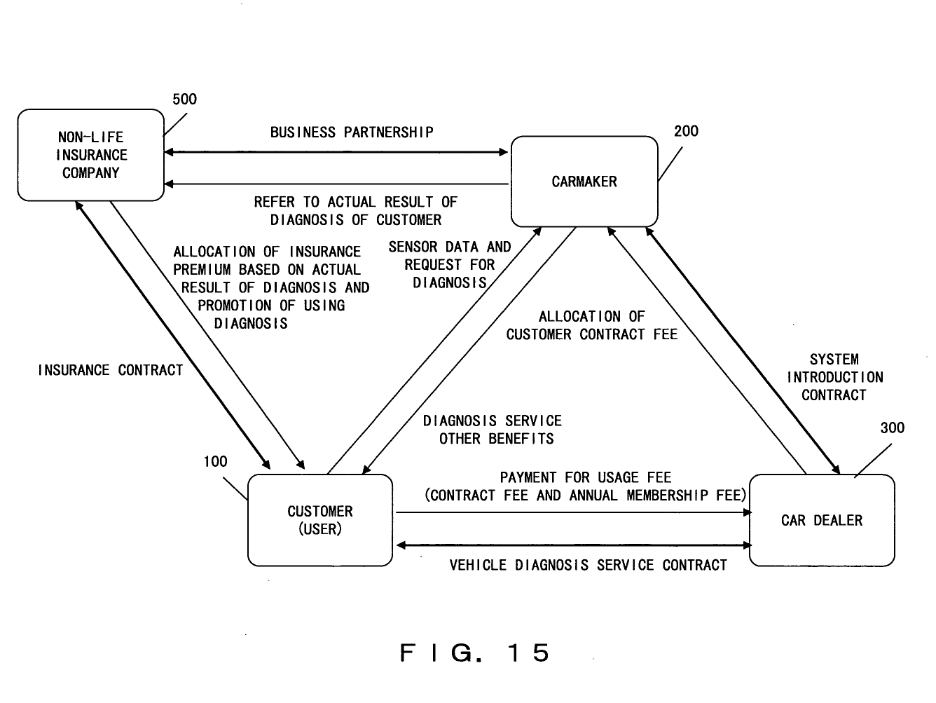

FIG. 15 is a diagram, according to a preferred embodiment of the present invention, for describing a third business model in an attempt to cooperate with non-life insurance companies. The carmaker 200 forms a partnership with a non-life insurance company 500, which provides the total benefits of the service provision system including diagnosis. The user 100 selects a partnered non-life insurance company 500 on the carmaker's 200 Web page and enters into a procedure for buying new insurance. The non-life insurance company 500 notifies the carmaker 200 of the establishment of the new insurance contract; thereby the non-life insurance company 500 becomes entitled to obtain information relating to an actual diagnosis of the user 100 from the carmaker 200 at anytime. Associated with the establishment of the user's 100 new insurance contract, the non-life insurance company 500 notifies the carmaker 200 of the user's 100 code number and the insurance subscriber/user's management number that is then stored as a collateral condition of the user 100 in a customer management database 10 retained by the carmaker's 200 diagnosis system shown in FIG. 10. A special code allowing the carmaker 200 to access only a contract user's actual diagnosis results is assigned to the non-life insurance company 500 by the carmaker 200 so as to enable the non-life insurance company 500 to monitor the insurance subscriber's actual diagnosis results automatically by accessing the carmaker's 200 system by using the non-life insurance company's 500 system (not shown in a drawing herein). Here, the actual result of the diagnosis, which is included in the customer management database 10, is defined as the user's 100 diagnosis request and the actual result of the security actions, and such, that are related to maintenance (including repair and such other factors that the car dealer 300 based the result of the diagnosis on. The non-life insurance company 500 obtains a mechanism to determine the amount of insurance premiums to be distributed to the user 100 at the close of an insurance subscription. These are determined by using the actual results of the diagnosis as an indicator, so that a link to the non-life insurance company's 500 system (not shown herein) makes it possible to automatically deposit an insurance premium allocation into the account of a user 100 at the close of an insurance subscription or start of a new contract. Meanwhile, the non-life insurance company 500 can make contact with a user 100 who has a low actual diagnosis result to better distribute insurance premiums; therefore, the non-life insurance company 500 is enabled to advise the user 100 from an earnest point of view and bring forth a favorable business system cycle, as compared to a case of the carmaker 200 prompting a request for diagnosis to a user 100 who has low actual diagnosis results.

The present business model is expected to be a service for improving the ratio of contracts for the non-life insurance company 500 and also as one for suppressing a total insurance payment. Building up such a business model enables the user 100 to proactively request diagnosis from the carmaker 200, enables the carmaker 200 to build up a database related to more abundant vehicle running conditions, and enables the non-life insurance company 500 to avoid the problem with insurance users subscribing because the non-life insurance company 500 can possess a fair indicator for distributing insurance premiums as a result of obtaining an actual formal diagnosis results from the carmaker 200 instead of self declarations from the user 100. These cycles bring about a favorable business cycle that has the possible social effect of decreasing the number of accidents due to a poor maintenance. Furthermore, improvements in the ratio of accidents due to poor maintenance and vehicle defects enables the non-life insurance company 500 to obtain actual user diagnosis results directly from a carmaker 200 so that the non-life insurance company 500 can allocate discount rates to each user 100, which enables her/him to be compensated for the present service provision system's membership fee when the user 100—who has subscribed to the service provision system including diagnosis—buys car insurance.

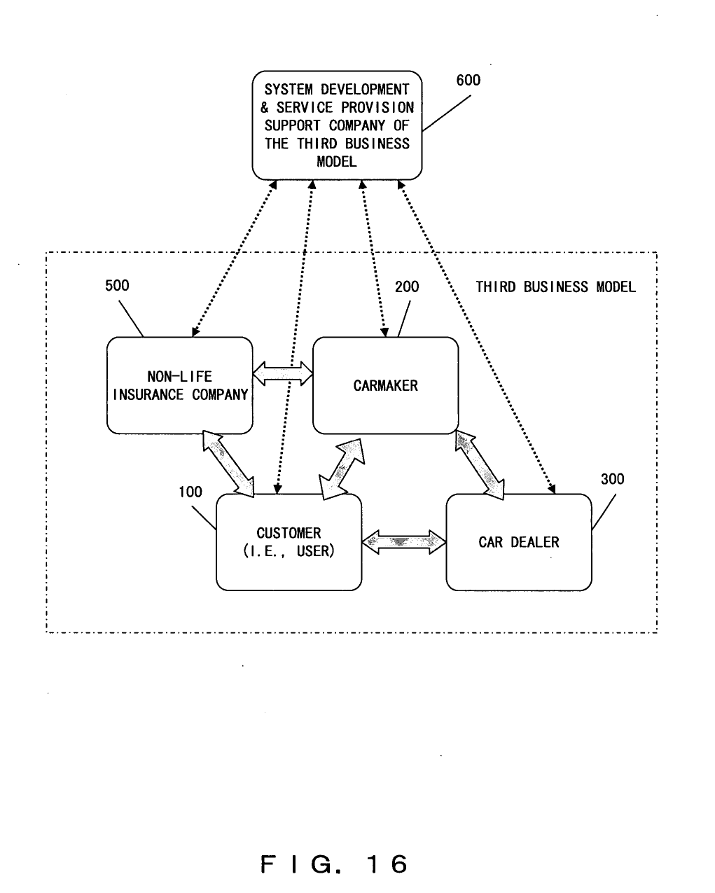

FIG. 16 is a diagram, according to a preferred embodiment of the present invention, that shows a fourth business model in which a service provision support company is separately established to comprehend the third business model shown in FIG. 15, and further develop that business model. Referring to FIG. 16, a service provision support company 600 develops a system related to the present business model for non-life insurance companies 500 and carmakers 200. It also receives allocations based on insurance contract fees from non-life insurance companies 500, allocations from user contract fees that are linked to a number of diagnosis service contracts, actual diagnosis results, and visits between users 100 and dealers. The service provision support company 600 carries out installation, maintenance management, and updates the system related to the car dealers 300 present business model and the interfaces between the user 100 and car dealer 300. The content of the interfacer is similar to the case described in FIG. 14; therefore, a description is omitted here.

As described above, a user of the present service contract subscribes to car insurance from a non-life insurance company on the carmaker's Web page or a service provision entity's Web page so that the non-life insurance company, while confirming the user's actual diagnosis results, promotes utilization of the user diagnosis system and allocates an insurance premium to the contract user based on the utilization of the diagnosis system. This thereby reduces the load on the user and, moreover, enables an effective buildup of the carmaker's database. It is also possible to reduce the user's annual membership fee on the present service contract to substantially zero as a result of receiving the insurance premium allocation from the non-life insurance company. Considering payments for other services, this may possibly make the service provision system appear attractive for users.

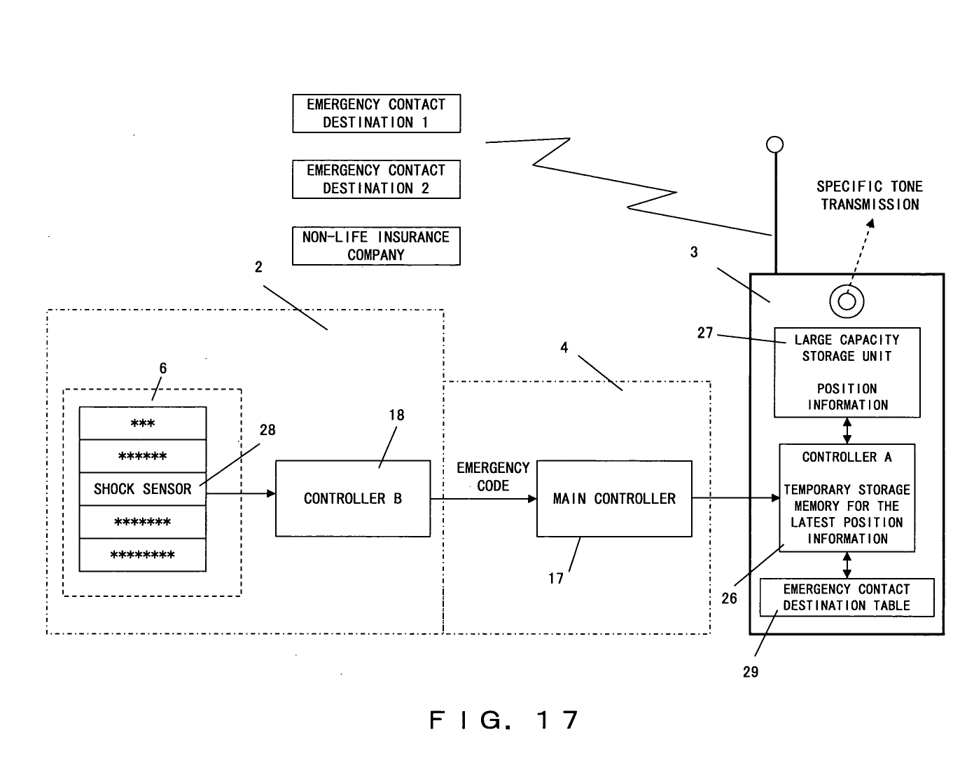

FIG. 17 is a functional block diagram, according to the present invention, related to a first embodiment for implementing an emergency communication in the service provision system. If an accident happens with only the user in the car, and if the user loses consciousness or cannot move herself/himself while conscious, a controller B18 interrupts the main controller's 17 process in the car A/V 4 and, upon detecting a level signal in excess of a certain level of an output signal of a shock sensor 28 (which is one of the in-vehicle sensors 6 equipped in the automobile 2), transmits an emergency code. Having received the emergency code, the main controller 17 instructs the portable phone 3 controller A26 to call at least one pre-registered emergency contact phone number and/or e-mail address from an emergency contact destination table 29 and transmit an emergency message to the call destination. The navigation system of the car A/V 4 is simultaneously instructed to transmit position information by converting the latest position information (i.e., latitude and longitude)—which is stored in a large capacity storage unit 27 equipped in the portable phone 3—into a voice and/or character. According to one embodiment, if the emergency contact destination is an individual user's personal contact, instead of a so-called emergency support center that is managed by the carmaker or entity of the present service provision, it becomes unnecessary for the carmaker or entity of the present service provision for personnel and equipment to respond to the emergency call. Therefore, it is possible to minimize the influence on the total service cost and free the user from a payment of an annual membership fee or the like for such an emergency contact service.

In an emergency situation resulting from an accident, the car A/V 4 that is equipped in the automobile 2 may fail, and consequently there is a conceivable possibility that the instruction to transmit an emergency contact becomes impossible.

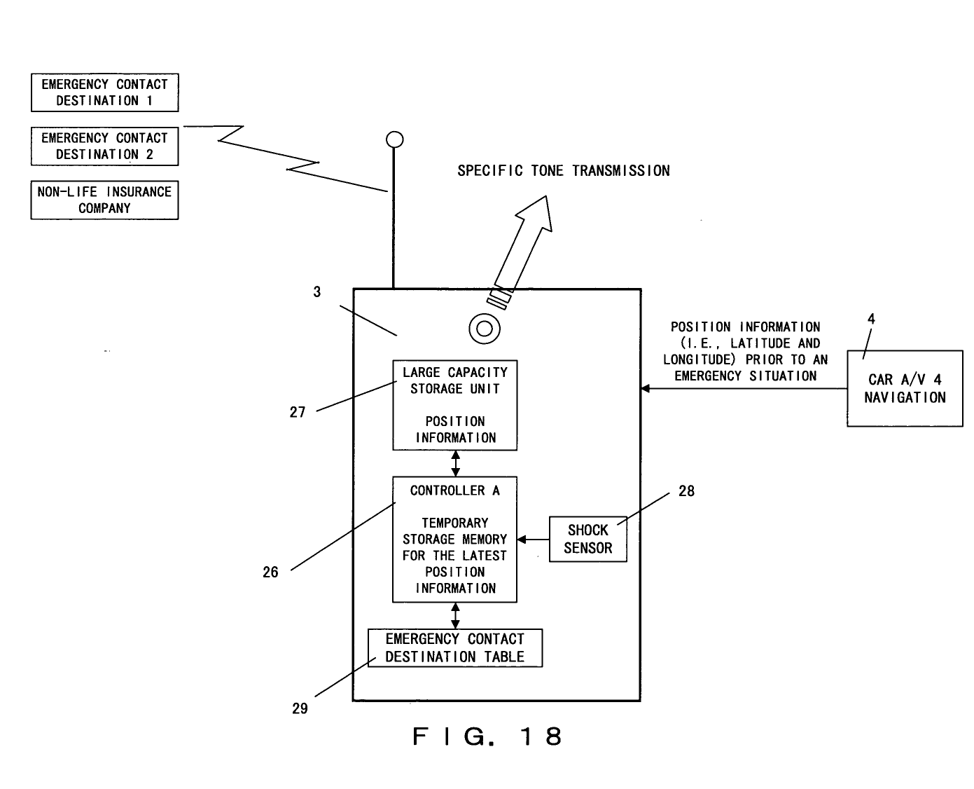

FIG. 18 is a functional block diagram, according to the present invention, related to a second embodiment for implementing an emergency communication in the service provision system. In order to respond to the case described above where the instruction for an emergency contact transmission is in the first functional block, the present embodiment is configured to incorporate a shock sensor 28 in the portable phone 3 as shown in FIG. 18. This enables the portable phone 3 to carry out an emergency contact without depending on the main controller 17 equipped in the car AV 4 (including a car navigation system). The controller A26 of the portable phone 3 detects a signal from the shock sensor 28 at a constant or at a certain time interval and issues an instruction for an emergency contact if a level signal is detected that is at or above a predetermined level.

If the large capacity storage unit 27 is a hard disk, there is a risk of failure if a large shock is applied. Therefore, the latest position information is stored in the semiconductor memory (not shown in a drawing herein), which is equipped in a controller A26 of a portable phone 3, until the next new position information is transmitted; thereby making it possible to increase the probability of carrying out an emergency contact. The semiconductor memory preferably uses a nonvolatile memory type.

Note that the portable phone 3 is configured to automatically transmit a specific tone, or the like, to an emergency contact when carrying it out regardless of the preferred embodiments shown in FIG. 17 or 18. However, the emergency contact can be cancelled by the user herself/himself by pressing the cancel button (not shown in the drawing herein) within a preset time if the user judges that the emergency contact is not necessary.

The present service provision system comprising the emergency contact function is very useful for responding to situations such when a user is alone and encounters an accident and/or loses consciousness. The present invention is contrived to accumulate pieces of position information obtained one after another from the car navigation system, thus making it possible to notify a call destination of the current position at an emergency contact and quickly call for a rescue. Registering a non-life insurance company as an emergency contact destination in the portable phone enables the non-life insurance company to contact the family and relatives; thereby providing a benefit of quick payment for medical bills, or other financial matters, that are carried out by the non-life insurance company.

The above descriptions of the present invention have concentrated on a common user vehicle when describing the service provision system. However, the present invention is also very useful for building up an important database and for managing the maintenance schedule if the service provision system is applied to heavy equipment (e.g., a bulldozer, crane, construction machine, et cetera). That is, a navigation system is not required in the case of heavy equipment, thus making it possible to provide a diagnosis service via a PC by transmitting diagnosis data obtained from in-vehicle sensors equipped in heavy equipment to a portable phone to be stored in a storage medium thereof. This is an extremely simple service compared to the service for a common user vehicle; yet, this is a service provision system capable of providing useful services to heavy equipment manufacturers or service provision entities in terms of building up a database and managing maintenance schedule (s).

In one embodiment of the present invention, the service provision system is configured to accumulate diagnosis data in portable information equipment and make a diagnostic decision based on a certain amount of ample data (in terms of time and driving distance). This diagnostic decision is sent to a user's PC by broadband telecommunications, thereby providing a highly accurate diagnosis system. The overall system is extremely simple and the user is totally free from paying telecommunication costs, especially when the annual membership fee is substantially lowered and the carmaker can obtain a large amount of information to use in the after market. This enables equipment to be developed from the customer's point of view because the system does not use the user's portable information equipment for telecommunication with the maker, non-life insurance company, dealer, or service provision support company. When the service provision system (including diagnosis of the present invention) is utilized for business, an individual's portable phone can be utilized without any telecommunications costs; thereby eliminating the need for a business entity to provide specific portable information equipment. Being free from cumbersome office work, such as settling expense accounts relating to operation costs (e.g., a telecommunication expense) makes this a convenient service provision system.

The first embodiment of the present invention is configured to accumulate sensor data while the vehicle is running as well as other run environment information (i.e., position information, car window picture, and local information) and store the information in a storage unit 27 equipped on a portable phone 3. The second embodiment of the present invention is configured to accumulate sensor data while the vehicle is running as well as other run environment information (i.e., position information, car window picture, and local information) from a car A/V having a built-in navigation system (i.e., an HDD navigation system) that incorporates a hard disk. The second embodiment accumulates sensor data while the vehicle is running as well as other run environment information and stores it on the HDD navigation's hard disk, thereby enabling the user to drive a car without carrying a portable phone with her/him. The user is enabled to receive similar service provisions as those described above in the first embodiment by importing the diagnosis data from the HDD navigation's hard disk to the portable phone's storage unit equipped on a later day.

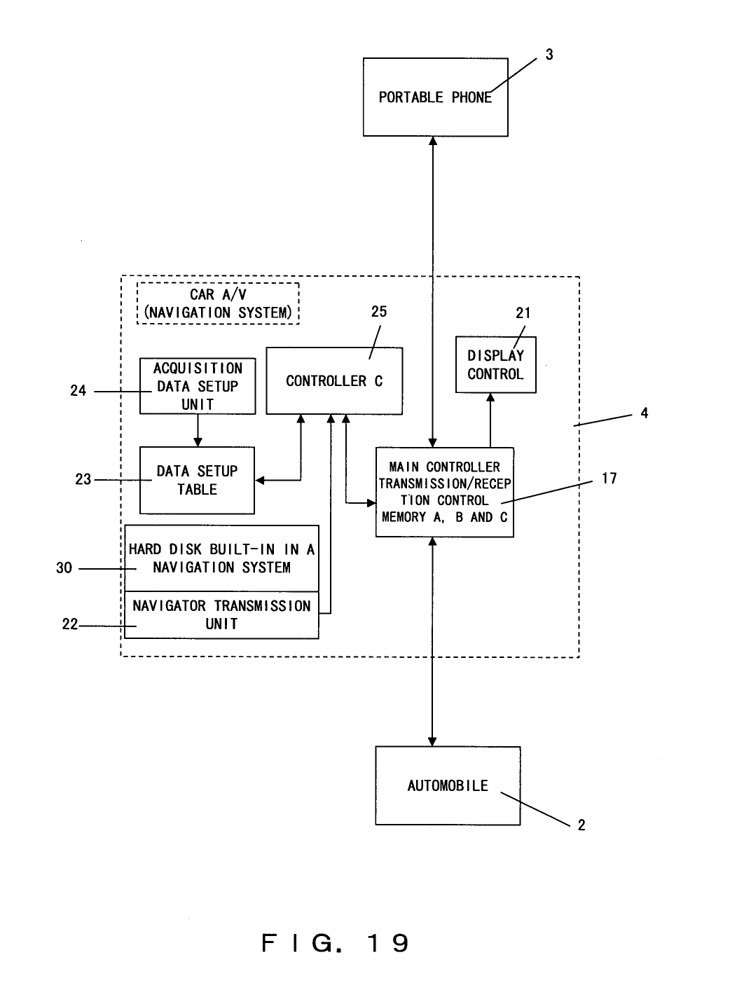

FIG. 19 is a block diagram showing a configuration for making a car A/V's navigation system's hard disk a diagnosis data storage medium in the service provision system (including diagnosis of the present invention.) In this configuration, car A/V's 4 navigation system's hard disk 30 is capable of accumulating data with or without a portable phone 3 being placed in a prescribed position of the vehicle. As previously described in FIG. 11, the in-vehicle sensor data stored in memory A, the navigation data stored in a second memory B, and the car window picture data stored in a third memory C, of the car A/V's main controller 17 are converted into a data block for each mutually identical time identifier. (In the conceivable case of a portable phone not being present in a car, the car window picture data in memory C would not exist.) The converted data block is transmitted to a car A/V 4 controller C25 by the main controller 17. The transmitted data blocks are stored on a hard disk 30 one by one for each data block by operating controller C25. Therefore, if the car is driven when a portable phone 3 is not connected for telecommunication, the diagnosis data accumulated on a hard disk 30 is transferred to a storage unit 27 equipped on a portable phone 3 by connecting it to a car A/V 4 for communicating and transferring data in accordance with the car A/V's 4 navigation operation screen.

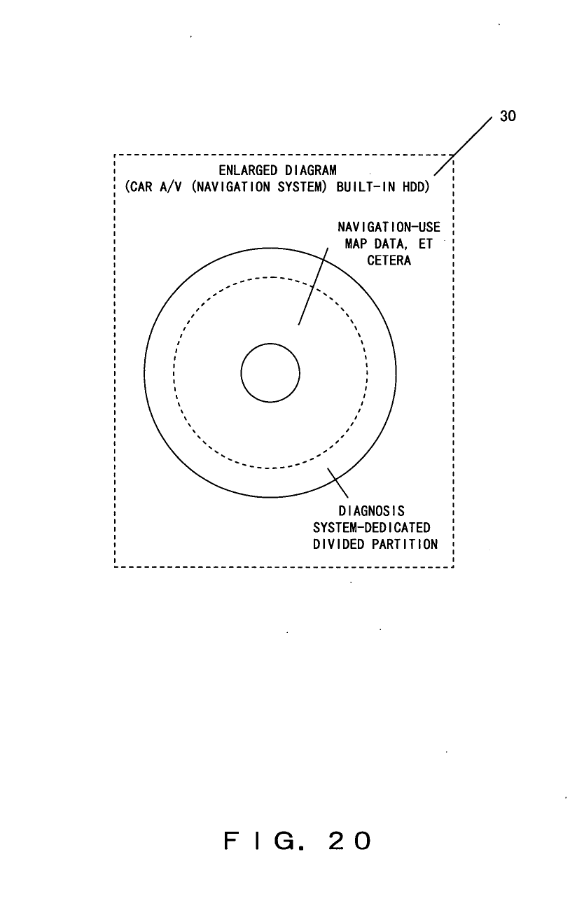

The following is a description of a transfer to a storage unit 27 equipped on a portable phone 3. The portable phone 3 is placed at a prescribed position and connected to a car A/V 4 for communication. Following this, a car A/V's 4 controller C25 extracts a data block that is attached with a time identifier which accumulates on a hard disk 30 in accordance with an instruction of a car A/V's main controller 17. The data block is transmitted to a portable phone's 3 controller A26 in accordance with the main controller's 17 transmission/reception control. A controller A26, in accordance with an application software format, converts the transmitted data blocks, one by one. The transmitted data blocks are pre-stored in a large capacity storage unit 27 that controls the display(s) and data array(s) to be compatible with operations from the user's home PC. The transmitted data blocks are sequentially stored on a portable phone's 3 large capacity storage unit. The hard disk 30 accumulates diagnosis data on a diagnosis system dedicated-use partition zone in the same manner as the portable phone's 3 storage unit 27 shown in FIG. 20. The remainder of the zone is configured to be a data zone for non-diagnosis system so as to pre-store such information as navigation-use map data.

The service provision system of the second embodiment of the present invention is configured to make the navigation system's hard disk function as a diagnosis data storage medium in place of portable information equipment possessed by the user. From the customer's point of view, this configuration also enables equipment to be developed by taking advantage of the user's portable information equipment, eliminating telecommunication costs for the portable information equipment (as illustrated in the case of the first embodiment,) and enabling the carmaker to use the present service provision system to obtain a large amount of data which can be utilized in the aftermarket. Particularly, when utilizing the service provision system (including diagnosis of the present invention for a business use), an individual's portable phone can be utilized and no telecommunication cost is required. Therefore, a business entity is not required to furnish specific portable information equipment and is completely free from cumbersome office processes such as settling expense accounts regarding operation costs (e.g., a telecommunication expense). Thus making this a convenient, user-friendly, service provision system.

The present invention is applicable to a service provision system that provides a diagnosis service for an operation condition of a user's mobile body. This invention includes a method for obtaining information related to an operation condition of a mobile body as well as information obtained from a navigation system and information obtained by the method. Additionally, this invention is configured to build up a database for a mobile body manufacturer and provide a service that is beneficial in building an alliance between affiliated companies.

The present invention is not only applicable to a user using a personal-use mobile body, but also to a user using a mobile body of a company such as a leasing company or taxi company.

What is claimed is:

1. A service provision system, at least comprising:
a portable information equipment being communicable with a car audio/video apparatus (A/V) equipped in a mobile body and having a storage medium accumulating information related to information of a run environment surrounding the mobile body; and
a service provision entity providing a service including a diagnosis of the mobile body based on the information accumulated on the storage medium of the portable information equipment, wherein
a car navigation system included in the car A/V provides the portable information equipment with position information as information of a run environment surrounding the mobile body,
the portable information equipment has a built-in camera which photographs a vehicle window picture as information of a run environment surrounding the mobile body, and
the storage medium stores the position information and the vehicle window picture together.

2. The service provision system according to claim 1, wherein
said car A/V comprises a data setup unit for setting a data acquisition condition of an in-vehicle sensor, wherein
said data setup unit performs a vehicle window picture setup related to a photographing condition of said built-in camera of said portable information equipment.

3. The service provision system according to claim 2, wherein
said data setup table storing a condition set by said data setup unit is comprised of nonvolatile memory.

4. The service provision system according to claim 1, wherein
said information related to information of a run environment of said mobile body is stored on a specific partition zone divided into a hard disk of said car navigation system.

5. The service provision system according to claim 4, wherein
said information related to said information of said run environment accumulated on said hard disk is sent to said portable information equipment.

6. The service provision system according to claim 1, wherein
said car navigation system comprises a navigator transmission unit, wherein
said navigator transmission unit controls navigator array data, adds a data identifier to each element of array data, further adds time of obtaining data in a set time interval to the head or tail end of the array data and stores the resultant in memory within the data transmission unit.

7. The service provision system according to claim 2, wherein
said car A/V makes it possible to handle said acquisition condition of said data setup unit in a display unit of said car navigation system.

8. The service provision system according to claim 7, wherein
said car A/V comprises a main controller, wherein
said main controller temporarily stores a run environment condition information which includes said time identifier and converts it to a data block for each mutually identical time identifier.

9. The service provision system according to claim 8, wherein
said main controller controls transmission and reception to and from said mobile body, and also controls transmission and reception to and from said portable information equipment.

10. A car audio/video apparatus (A/V), comprising:
a car navigation system for obtaining position information;
a main controller for controlling transmission(s) and reception to and from a mobile body and also controlling transmission and reception to and from a portable information equipment; and
a memory for storing a vehicle window picture photographed by a built-in camera in the portable information equipment and the position information together.

11. The car A/V according to claim 10, wherein
said main controller temporarily stores position information which includes a time identifier, vehicle window picture information photographed by a built-in camera of said portable information equipment and information related to said operating condition obtained from said in-vehicle sensor equipped in said mobile body, converts them into a data block for each mutually identical time identifier.

12. A portable information equipment being communicable with a car audio/video apparatus (A/V) equipped in a mobile body and comprising a storage medium accumulating information related to information of a run environment surrounding the mobile body, comprising
a camera, wherein
said camera photographs a vehicle window picture as information of said run environment surrounding said mobile body and provides the vehicle window picture,
a car navigation system included in said car A/V provides position information as information of said run environment surrounding said mobile body, and
said storage medium stores said position information and said vehicle window picture together.
